(19) United States
(12) Patent Application Publication
(10) Pub. No.: US 2025/0224065 A1
(43) Pub. Date: Jul. 10, 2025

(54) Expansion Device

(71) Applicant: Hydac Technology GmbH, Sulzbach / Saar (DE)

(72) Inventors: Peter Kloft, Ransbach-Baumbach (DE); Jens Holger Köhne, Saarbrücken (DE); Lars Müller-Tönnissen, Düsseldorf (DE)

(73) Assignee: Hydac Technology GmbH, Sulzbach / Saar (DE)

(21) Appl. No.: 18/853,300

(22) PCT Filed: Mar. 14, 2023
(86) PCT No.: PCT/EP2023/056484

§ 371 Date: Oct. 1, 2024

(30) Foreign Application Priority Data
Apr. 2, 2022 (DE) 10 2022 001 144.1

(51) Int. Cl. F16L 55/053

(52) U.S. Cl. CPC F16L 55/053

(57) ABSTRACT

Disclosed is an expansion device having an expansion housing, which has a separating membrane, which separates the expansion housing into two media chambers, of which one media chamber can be filed with liquid via a liquid connection in the expansion housing, characterised in that the other media chamber is permanently connected to the environment via at least one opening in the expansion housing, even during operation of the device, in such a way that ambient pressure prevails in the other media chamber.

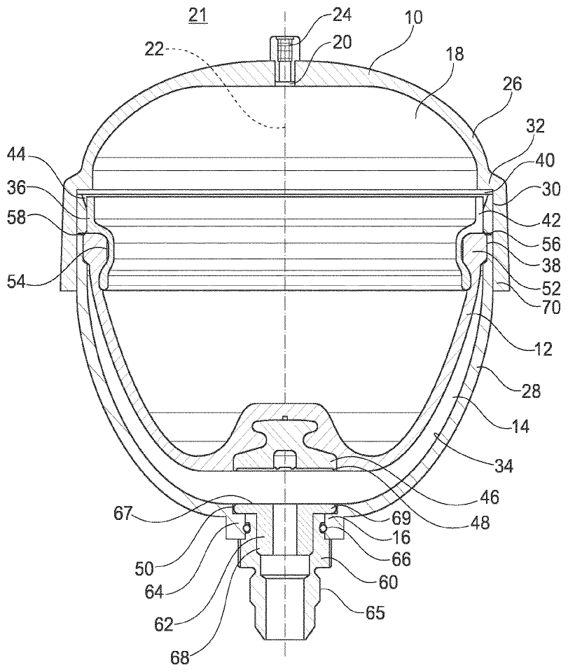

### CROSS-REFERENCE TO RELATED APPLICATIONS

This application claims priority to German Patent Application No. DE 10 2022 001 144.1, filed on Apr. 2, 2022 with the German Patent and Trademark Office. The contents of the aforesaid patent application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to an expansion device having an expansion housing, which has a separating membrane, which separates the expansion housing into two media chambers, of which one media chamber can be filled with liquid via a liquid connection in the expansion housing.

DE 43 02 356 C2 discloses a safety group having an expansion vessel for installation in a cold-water pipe which is connected to a pressure-resistant water heater, the expansion vessel having a membrane and a pipe section, on the inlet side of which a return-flow preventer and downstream a safety valve are arranged. The pipe section is provided with openings and the membrane of the expansion vessel consists of a flexible hose which is shrunk onto the pipe section and surrounded by a pressure accumulator housing which is filled via a connection with a gas, for example nitrogen, at a predefinable pressure.

Since the known expansion vessels are continuously exposed to a relevant operating pressure, formed by the working gas accommodated in a sealed chamber in each case, they are subject to the European Pressure Equipment Directive which was implemented in Germany within the framework of the Pressure Equipment Regulation. Pressure vessels, if they are operated with a maximum permissible pressure greater than 0.5 bar, are already covered by the aforementioned regulation which means that they are subject to an internal inspection or visual inspection at certain intervals, and a strength test, also known as a pressure test, must also be carried out at longer intervals, which is correspondingly time-consuming and cost-intensive, and the monitoring periods for compliance therewith must also be monitored.

### SUMMARY

A need exists to provide an improved expansion device. The need is addressed by the subject matter of the independent claim(s).

### BRIEF DESCRIPTION OF THE DRAWING

The only FIG. shows some components of an example expansion device in the manner of a longitudinal section.

### DESCRIPTION

The details of one or more embodiments are set forth in the accompanying drawing and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, the expansion devices only need to equalize a pendulum volume of liquid at more or less normal pressure, which does not require any high-pressure-resistant vessels with enclosed gas volumes of a predefinable pressure that is regularly above the limit value of 0.5 bar according to the Pressure Equipment Directive or the Pressure Equipment Regulation.

In some embodiments, it is provided that the other media chamber is permanently in communication with the environment via at least one opening in the expansion housing, even during operation of the device, in such a manner that ambient pressure prevails in the other media chamber. Accordingly, liquid at a predefinable pressure and volume can still flow into the one media chamber of the expansion housing with the result that the elastic separating membrane bulges out towards the other media chamber and in the process displaces the ambient air from this other media chamber towards the outside via the respective opening in the expansion housing. If the pendulum volume of liquid from the one media chamber of the vessel is then retrieved again, the membrane relaxes once again and returns to its initial state, air then being “sucked back” once more into the other media chamber via the respective opening to the environment for the purpose of equalization. With the expansion device according to the teachings herein, it is accordingly possible to use it for a plurality of applications where only a predefinable pendulum volume has to be equalized on the liquid side without having to comply with the stringent regulations in the field of constantly pressurized containers that have working pressures greater than 0.5 bar.

The expansion device is particularly suitable for connection to fluid circuits of any kind, in particular in the form of hydraulic circuits. In aircraft, due to the wide range of operating temperatures from +40 to −56° C. (ISA temperature), the hydraulic oil basically enclosed in hydraulic working circuits can expand or contract and the resulting pendulum volume in the hydraulic circuit can be equalized in a functionally safe manner with the expansion device according to the teachings herein with little design effort. This thus has no equivalent in prior art.

In some embodiments of the expansion device, it is provided that the liquid connection and the at least one opening for the ambient air to pass into the other media chamber are arranged on opposing end faces of the expansion housing. In this way, a vertical orientation is substantially predetermined for the expansion housing during its operation, and the pendulum volume to be accommodated can enter and exit the one media chamber without constraint under the effect of gravity. The fact that the air opening is arranged at the top of the expansion housing results in particularly good flow conditions when the air enters and exits the other media chamber, the respective volume of which predetermined via the expansion size of the elastic separating membrane which in this respect is exposed to the pendulum volume on the liquid side.

In some embodiments of the expansion device, it is provided that the at least one opening in the expansion housing for the passage of air is used to accommodate an air filter. In this way, the quantity of air flowing into the expansion housing can be cleaned of particle contamination. If configured accordingly, the air filter is also capable of separating moisture components from the ambient air in the usual way.

In some embodiments of the expansion device, the expansion housing consists of two shell-like housing parts which are bonded together and consist of plastic materials, for example conventional composites. Since the vessel-like expansion housing is not exposed to any high pressures, and in particular is only subject to ambient pressure, this facilitates a configuration in lightweight construction made of plastic.

In some embodiments of the expansion device, it is provided that the one housing part with the respective opening engages over the other housing part with the liquid connection and that a retaining ring is inserted on the inner circumference of the other housing part with the liquid opening in the region of the overlap, which retaining ring presses the membrane into an annular recess of the other housing part. In this way, an airtight connection is achieved between the housing parts, and the membrane is fixed at the edge in the expansion housing in a defined manner by means of the retaining ring without additional fixing means. In this case, the one housing part with the opening for example protrudes inwards in the region of the retaining ring and in this way engages over the other housing part and the retaining ring which, in conjunction with the shell-like structure of the housing parts, nevertheless results in a pressure-stable configuration of the expansion housing.

In some embodiments of the expansion device, it is provided that an axial gap is present at the point of the overlap between the other housing part with the retaining ring and the one housing part. This creates a kind of tolerance compensation so that the retaining ring with the membrane can be securely installed in the shell arrangement of the housing parts in any case.

The membrane for example consists of a shell-like elastomer body which has a closing part on the bottom for sealing the liquid connection when the housing part is completely evacuated on its liquid side. In this way, the membrane moves easily into its closed position and the liquid can be completely evacuated from the other housing part.

In some embodiments of the expansion device, it is further provided that the separating membrane has a bead-like thickening which, with a radially protruding lip, engages in an associated annular gap in the other housing part. This provides an additional fixing option for the marginal end of the membrane in the other housing part.

In some embodiments of the expansion device, it is provided that the liquid connection in the other housing part has two connection parts which engage through the liquid connection and, secured together, clamp the other housing part between them in an edge region to the liquid connection. In this way, the other housing part, which may be glass-fiber reinforced, is safely penetrated by the metallic materials of the connection parts, so that despite the lightweight construction of the housing, a robust connection option per se is created for hydraulic circuits with their standardized connection geometries.

The expansion device is explained in greater detail below with reference to an embodiment according to the drawing which shows components of the expansion device in the manner of a longitudinal section in the only FIG.

Specific references to components, process steps, and other elements are not intended to be limiting.

The expansion device according to the FIG. has an expansion housing 10 with a separating wall in the form of an elastic separating membrane 12 arranged therein. The separating membrane 12 separates the housing 10 in its interior into a media chamber 14, which can be filled with liquid via a liquid connection 16, for example in the form of a hydraulic oil. If necessary, liquid can also be discharged from the media chamber 14 via the aforementioned liquid connection 16, which is usually connected to a hydraulic supply device not shown in greater detail. Viewed in the direction of the FIG., another, second media chamber 18 is arranged above the separating membrane 12, which media chamber is permanently connected to the environment 21 via an opening 20 in the expansion housing 10, even during operation of the device, in such a way that ambient pressure prevails in the aforementioned other media chamber 18.

As can further be seen from the FIG., the liquid connection 16 and the opening 20 for the ambient air to pass into the other media chamber 18 are arranged on opposing end faces of the expansion housing 10, namely in a coaxial arrangement with respect to a longitudinal axis 22 of the expansion housing 10.

In some embodiments of the expansion device, it is further provided, according to the diagram shown in the FIG., that the one opening 20 in the expansion housing 10 for the passage of air is used to accommodate an air filter 24, which is held in the opening 20 in the manner of a screw-in replacement cartridge. If the air filter 24 is clogged with particle contamination from the ambient air, it can then easily be replaced with a new air filter 24.

The expansion housing 10 is substantially formed of two shell-like housing parts 26, 28 which are bonded together along a predefinable bonding section 30 and consist of plastic materials, for example of glass-fiber reinforced plastic. However, it is also perfectly possible to manufacture the housing parts 26, 28 from die-cast aluminum parts and the like. Instead of the aforementioned bonding via a bonding section 30, a different connection can also be provided, for example the two housing parts 26, 28 can be screwed together in an embodiment not shown in greater detail.

The upper housing part 26 with the opening 20 engages along a protruding edge 32 over the other housing part 24 with the liquid connection 16 and in the region of this overlap a retaining ring 36 is inserted on the inner circumference 34 of the other housing part 28 with the liquid connection 16, which retaining ring presses the separating membrane 12 into an annular recess 38 of the other housing part 28. An axial gap, viewed in the longitudinal orientation of the longitudinal axis 22, is present at the point of the overlap between the other housing part 28 with the retaining ring 36 and the one housing part 26. The retaining ring 36 rests on a protruding contact surface 42 of the other housing part 28. Viewed in the direction of the FIG., the annular recess 38 is present below the annular contact surface 42 and, above said recess, the contact surface 42 tapers into an outwardly widening cone 44, the upper end-face boundary wall of which, viewed in the horizontal direction, also defines the gap 40 downwards.

The separating membrane 12 consists of a shell-like elastomer body which has a closing part 46 on the bottom for sealing the liquid connection 16 when the housing part 28 is completely evacuated on its liquid side or on the side of the one media chamber 14. The closing part 46 is configured in the manner of a solid valve disc and is molded, in particular “buttoned”, into the lower end of the membrane body of the separating membrane 12. The disc-like closing part 46 is arranged concentric with the longitudinal axis 22 and the circumferential diameter of the closing part 46 is in any case selected in such a manner that a downwardly protruding closing edge, which closes flush with the free end face of the separating membrane 12, comes into contact with a free circumferential edge 50, which defines the liquid connection 16 on the opposing inner side of the other housing part 28.

Furthermore, the separating membrane 12 has a bead-like thickening 52 on its outer free end, which is bordered towards the outside by the annular recess 38 and on the inside towards the longitudinal axis 22 by a concave recess 54 in the retaining ring 36. The retaining ring 36 is for example configured as an elastically yielding plastic clip part which can be inserted from above along the free opening of the other housing part 28 and can be snap-fastened thereto along the contact surface 42 via the thickening 52. Due to the elastic pretension, the retaining ring 36 forms a kind of retaining bracket for the thickening 52 of the separating membrane 12. For securely fastening the separating membrane 12 in the other housing part 28, it is additionally provided that the thickening 52 has a radially protruding, thin-walled lip 56 on its upper end which engages flush in an associated annular gap 58 in the other housing part 28. In this way, the separating membrane 12 is also securely anchored in the other housing part 28 in an axial direction, viewed parallel to the longitudinal axis 22.

As can also be seen from the FIG., the liquid connection 16 in the other housing part 28 has two connection parts 60, 62, which engage through the liquid connection 16 and, secured together, clamp the other housing part 28 between them in an edge region 64 of the liquid connection 16. Towards its free end face, the one connection part 60 has an external thread 65, not shown in greater detail, via which the expansion device as a whole with the expansion housing 10 can be connected to a hydraulic supply circuit (not shown) in the usual way. On the outer circumference, the one connection part 60 has an O-sealing ring 66 for the purpose of sealing a possible leakage point from the first media chamber 14 towards the environment 21. In this respect, the O-sealing ring 66 is in sealing contact with the inner circumference of the edge region 64 of the other housing part 28. From the inside, the further connection part 62 is inserted first, which with its free upper end face forms a flat contact surface 67 transverse to the longitudinal axis 22 for contact with the closing part 46, provided that the media chamber 14 is completely evacuated of liquid. The connection part 62 has an external thread 68 along a cylindrical, hollow engagement stub via which the hollow cylindrical connection part 60 can be screwed onto the connection part 62 from the outside with a correspondingly configured internally threaded section. If the two connection parts 60, 62 are fixed to each other in this way via the specified threaded section, the edge region 64 is firmly clamped between the connection parts 60, 62, for which purpose the connection part 62 has a flange-like widening 69 towards the closing part 46, the outer diameter of which corresponds to the outer diameter of the edge 48 of the closing part 46.

In addition or alternatively to the bonding section 30, the upper housing part 26 can also be configured as a clip part with a widened outer edge 70 and can be clipped onto the lower housing part 28. In this way, a housing structure is achieved which can be produced simply and inexpensively, and which can dispense with the usual joining techniques, such as bonding, screwing, etc., for connecting the housing parts 26, 28 to each other, and a clip or snap-in connection is therefore possible because only ambient pressure prevails in the other media chamber 18 via the opening 20 or via the air filter 24. In any case, the free edge of the outer wall 70 protrudes beyond the lower end face of the retaining ring 36, viewed in a horizontal plane. To apply the necessary retention forces, the circumferential outer wall 70 is widened in diameter towards its free end.

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments. The term “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1-10. (canceled)

11. A expansion device having an expansion housing, which has a separating membrane, which separates the expansion housing into two media chambers, of which a first media chamber can be filled with liquid via a liquid connection in the expansion housing, wherein a second media chamber of the two media chambers is permanently connected to the environment via at least one opening in the expansion housing, even during operation of the device, in such a way that ambient pressure prevails in the second media chamber.

12. The expansion device of claim 11, wherein the liquid connection and the at least one opening for the ambient air to pass into the second media chamber are arranged on opposing end faces of the expansion housing.

13. The expansion device of claim 11, wherein the at least one opening in the expansion housing for the passage of air is used to accommodate an air filter.

14. The expansion device of claim 11, wherein the expansion housing consists of a first and a second shell-like housing part which housing parts are bonded together and consist of plastic materials.

15. The expansion device of claim 14, wherein the first housing part with the at least one opening engages over the second housing part with the liquid connection and wherein a retaining ring is inserted on the inner circumference of the second housing part with the liquid connection in the region of the overlap, which retaining ring presses the separating membrane into an annular recess of the second housing part.

16. The expansion device of claim 14, wherein the first housing part with the opening protrudes inwards in the region of the retaining ring and engages over the second housing part and the retaining ring.

17. The expansion device of claim 14, wherein an axial gap is present at the point of the overlap between the second housing part with the retaining ring and the first housing part, and wherein the second housing part rests on the retaining ring with a protruding contact surface.

18. The expansion device of claim 14, wherein the separating membrane consists of a shell-like elastomer body which has a closing part on the bottom for sealing the liquid connection when the second housing part is completely evacuated on its liquid side.

19. The expansion device of claim 14, wherein the separating membrane has a bead-like thickening which, with a radially protruding lip, engages in an associated annular gap in the second housing part.

20. The expansion device of claim 14, wherein the liquid connection in the second housing part has two connection parts which engage through the liquid connection and, secured together, clamp the second housing part between them in an edge region of the liquid connection.

21. The expansion device of claim 12, wherein the at least one opening in the expansion housing for the passage of air is used to accommodate an air filter.

22. The expansion device of claim 12, wherein the expansion housing consists of a first and a second shell-like housing part which housing parts are bonded together and consist of plastic materials.

23. The expansion device of claim 13, wherein the expansion housing consists of a first and a second shell-like housing part which housing parts are bonded together and consist of plastic materials.

24. The expansion device of claim 15, wherein the first housing part with the opening protrudes inwards in the region of the retaining ring and engages over the second housing part and the retaining ring.

25. The expansion device of claim 15, wherein an axial gap is present at the point of the overlap between the second housing part with the retaining ring and the first housing part, and wherein the second housing part rests on the retaining ring with a protruding contact surface.

26. The expansion device of claim 16, wherein an axial gap is present at the point of the overlap between the second housing part with the retaining ring and the first housing part, and wherein the second housing part rests on the retaining ring with a protruding contact surface.

27. The expansion device of claim 15, wherein the separating membrane consists of a shell-like elastomer body which has a closing part on the bottom for sealing the liquid connection when the second housing part is completely evacuated on its liquid side.

28. The expansion device of claim 16, wherein the separating membrane consists of a shell-like elastomer body which has a closing part on the bottom for sealing the liquid connection when the second housing part is completely evacuated on its liquid side.

29. The expansion device of claim 17, wherein the separating membrane consists of a shell-like elastomer body which has a closing part on the bottom for sealing the liquid connection when the second housing part is completely evacuated on its liquid side.

30. The expansion device of claim 15, wherein the separating membrane has a bead-like thickening which, with a radially protruding lip, engages in an associated annular gap in the second housing part.
